(19) United States
(12) Patent Application Publication
(10) Pub. No.: US 2009/0055661 A1
(43) Pub. Date: Feb. 26, 2009

(54) ALWAYS-ON SYSTEM

(76) Inventor: Kuo-Hsien KUO, Taichung City (TW)

Correspondence Address: SINORICA, LLC, 528 FALLSGROVE DRIVE, ROCKVILLE, MD, 20850, US

(21) Appl. No.: 11/841,656

(22) Filed: Aug. 20, 2007

(51) Int. Cl. G06F 1/26

(52) U.S. Cl. 713/300

(57) ABSTRACT

The invention relates to an always-on system mainly provided with a control unit to govern a power supply switch unit. When one of main power supply units or a bypass power supply unit of an external power supply device is to be installed or uninstalled, a user can operate the control unit to enable the power supply switch unit to switch to the main power supply unit or the bypass power supply unit that is not to be installed or uninstalled to provide power for loads connected with the always-on system to operate continuously, without interrupting the operation of the load.

### BACKGROUND OF THE INVENTION

1. Field of the Invention

This invention relates to an always-on system, particularly to one able to keep loads connected with the always-on system continuing to run while installing or uninstalling a main power supply unit or a bypass power supply unit of an external power supply.

2. Description of the Prior Art

As people rely more and more on technical products in daily life, the demand for stable power for such products has always been improved. As shown in FIG. 1, in order to solve that a load 1 is improperly shut down owing to a sudden break down of an external power supply 2, a conventional uninterruptible power system 3, so called UPS, is commonly connected between the load 1 and the external power supply 2, so as to enable the load 1 to be normally shut down with sufficient time. And, the load 1 can be booted again as soon as the external power supply 2 is restored to supply power. However, if the interruptible power system 3 is found abnormal, having to be disassembled for repair, it can not be disconnected until the load 1 is completely shut down. In addition, the load 1 must be connected to the external power supply 2 or other spare power supply before the interruptible power system 3 is fixed up, if the load 1 has to be operated continuously. And, as the interruptible power system 3 has been mended to be installed again between the load 1 and the external power supply 2, the load 1 must be in advance operated once again as the procedure mentioned previously. So, such an interruptible power system 3 may cause not only inconvenience to a user, but also a raise of cost and a waste of time by interruption of work.

### SUMMARY OF THE INVENTION

The objective of this invention is to offer an always-on system.

The always-on system according to the invention is mainly provided with a control unit to govern a power supply switch unit. When one of a main power supply unit and a bypass power supply unit of an external power supply device is to be installed or uninstalled, the control unit can transmit an enabling signal to the power supply switch unit, which, orderly connected with a protection circuit unit and a power supply input unit, is then able to select a main power supply input terminal or a bypass power supply input terminal of the power supply input unit to provide power for the always-on system to keep loads connected with the always-on system continuing to work without being affected by installing or uninstalling the external power supply device. Therefore, there is nothing happening to cost loss.

### BRIEF DESCRIPTION OF DRAWINGS

This invention is better understood by referring to the accompanying drawings, wherein:

FIG. 1 is a block diagram of a conventional connecting system relating to an external power supply, an uninterruptible power system (UPS) and a load;

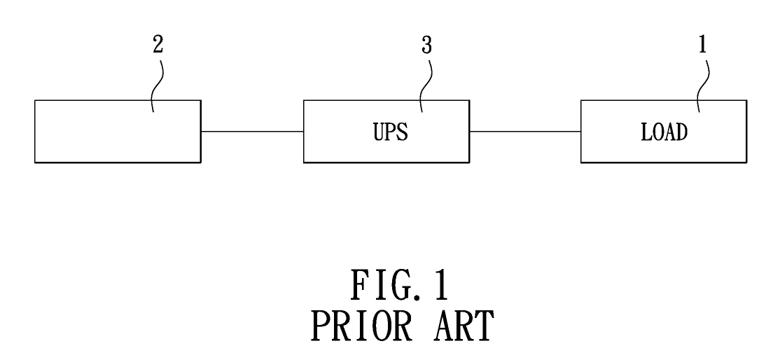

FIG. 2 is a block diagram of a connecting system relating to a preferred embodiment of an always-on system in the present invention;

FIG. 3 is a block diagram of an electric circuit of the preferred embodiment of an always-on system in the present invention;

FIG. 4 is a wired view of a first example of connecting system of the preferred embodiment of an always-on system in the present invention;

FIG. 5 is a wired view of a second example of connecting system of the preferred embodiment of an always-on system in the present invention;

FIG. 6 is a wired view of a third example of connecting system of the preferred embodiment of an always-on system in the present invention; and

FIG. 7 is a wired view of a fourth example of connecting system of the preferred embodiment of an always-on system in the present invention.

### DETAILED DESCRIPTION OF THE PREFERRED EMBODIMENT

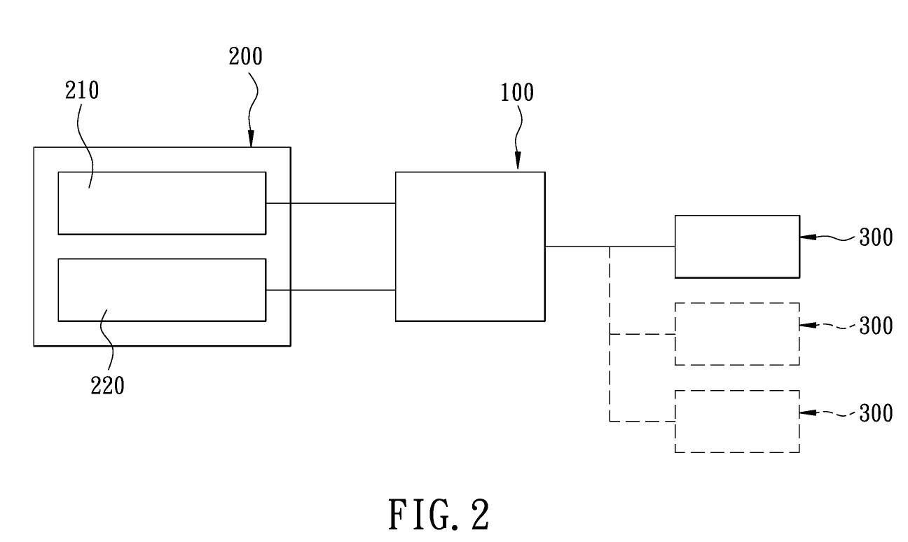

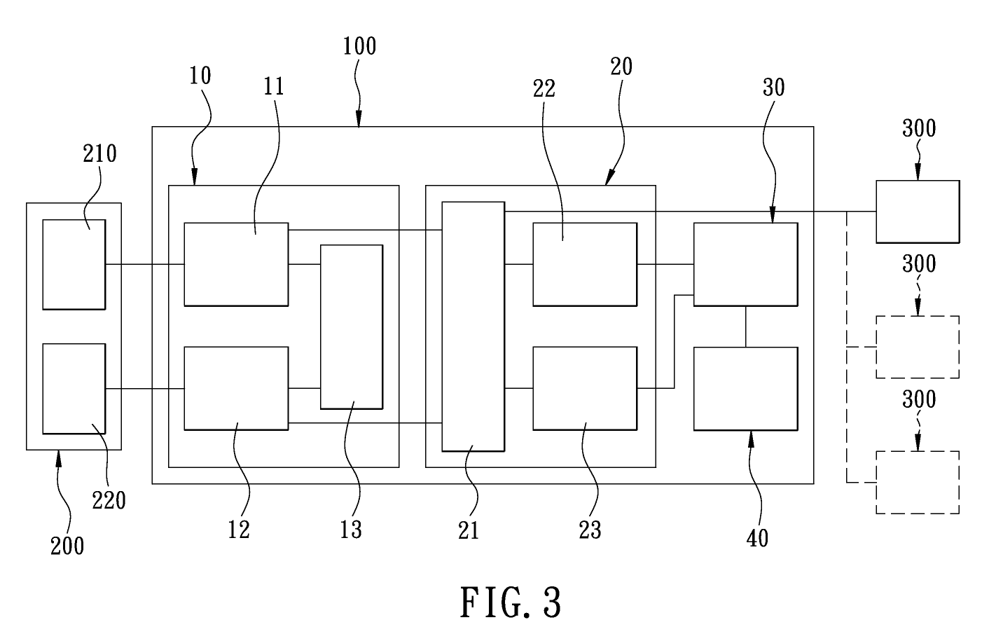

FIGS. 2 and 3 show a preferred embodiment of an always-on system 100 in the present invention, which is connected with an external power device 200 at one side for providing diverse power supplies, and plural loads 300 at the other side. The external power supply device 200 is provided with a main power supply unit 210 and a bypass power supply unit 220. The always-on system 100 is mainly composed of a power supply input unit 10, a protection circuit unit 20, a power supply switch unit 30 and a control unit 40.

The power supply input unit 10 is provided with a main power supply input terminal 11, a bypass power supply input terminal 12 and a power supply asynchronous detecting circuit 13 connected with the main power supply input terminal 11 and the bypass power supply input terminal 12 respectively. The power supply asynchronous detecting circuit 13 is employed to detect if the phase of power supply transmitted from the main power supply unit 210 of the external power supply device 200 connected with the main power supply input terminal 11 is synchronous with that of another power supply transmitted from the bypass power supply unit 220 of the external power supply device 200 connected with the bypass power supply input terminal 12.

The protection circuit unit 20 is composed of a filtering circuit 21, a delay protection circuit 22 and an error protection circuit 23. The filtering circuit 21 is connected with the main power supply input terminal 11 and the bypass power supply input terminal 12 of the power supply input unit 10 respectively at one side to isolate noise of surge and harmonic created in current circuit while external power supply is transmitted from the external power supply device 200, and connected with the delay protection circuit 22, the error protection circuit 23 and the loads 300 at another side respectively. The delay protection circuit 22 is used for preventing the external power supply from generating intermittent signals that may provoke the always-on system 100 to function in error. The error protection circuit 23 is used to automatically select the main power supply input terminal 11 connected with the main power supply unit 210 to provide power from another power supply in case that the bypass power supply input terminal 12 connected with the bypass power supply unit 220 is an open circuit, but selected by the always-on system 100.

The power supply switch unit 30 is connected with the delay protection circuit 22 and the error protection circuit 23 of the protection circuit unit 20 respectively at one side, for receiving enabling signals transmitted by the delay protection circuit 22 and the error protection circuit 23. When power supply is transmitted through the main power supply input terminal 11 connected with the main power supply unit 210 of the external power supply device 200, the power supply switch unit 30 can switch to the bypass power supply input terminal 12 connected with the bypass power supply unit 220 to provide power through another power supply, keeping the loads 300 connected with the always-on system 100 operating continuously without any influence. It works on the contrary, as well. The power supply switch unit 30 is a switch circuit based on insulated gate bipolar transistors (IGBT), conventional transistors, relays or their combination. IGBT is selected in the preferred embodiment of the present invention.

The control unit 40 is connected with the power supply switch unit 30 at its one side, able to generate an enabling signal to control the power supply switch unit 30 to select the main power supply input terminal 11 or the bypass power supply input terminal 12 of the always-on system 100 for being transmitted with external power supply when the main power supply unit 210 of the external power supply device 200 or the bypass power supply unit 220 is being installed or uninstalled. The control unit 40 in the preferred embodiment of the present invention is operated manually.

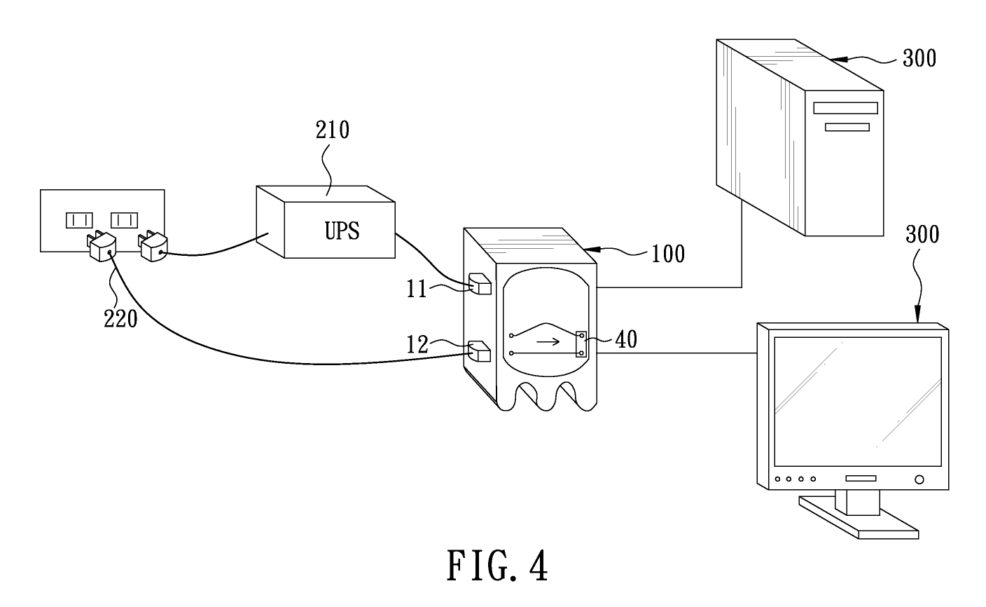

FIG. 4 shows a first example of the preferred embodiment of the present invention in using, wherein the main power supply unit 210 of the external power supply device 200 is an uninterruptible power system (UPS) connected with the main power supply input terminal 11 of the always-on system 100, and the bypass power supply unit 220 of the external power supply device 200 is an external power supply directly connected with the bypass power supply input terminal 12. So, the loads 300 are operated by means of the power provided by the always-on system 100 connected therewith. If the main power supply unit 210 is found abnormal to be uninstalled, a user needs only to press down the control unit 40 of the always-on system 100 to make the power supply switch unit 30 switch to the bypass power supply input terminal 12 connected with the bypass power supply unit 220 to provide power for the loads 300 to keep on operating without being shut down for connecting with another power supply, affecting nothing of scheduled work.

After the main power supply unit 210 has been fixed up, it can be directly connected with the main power supply input terminal 11. Then, press down again the control unit 40 to make the power supply switch unit 30 switch back to the main power supply input terminal 11 connected with the main power supply unit 210 to provide power for the loads 300 to go on without being affected. In addition, if a user forgets to switch the bypass power supply input terminal 12 to the main power supply input terminal 11 after having the main power supply unit 210 connected with the main power supply input terminal 11 of the always-on system 100, and the bypass power supply unit 220 stops providing power because of power cut or other unexpected reasons, the error protecting circuit 23 of the always-on system 100 is to send an enable signal to the power supply switch unit 30 that is to immediately switch to the main power supply input terminal 11 connected with the main power supply unit 210 (UPS) to provide power for the loads 300, for preventing the loads 300 from damaged owing to man's carelessness.

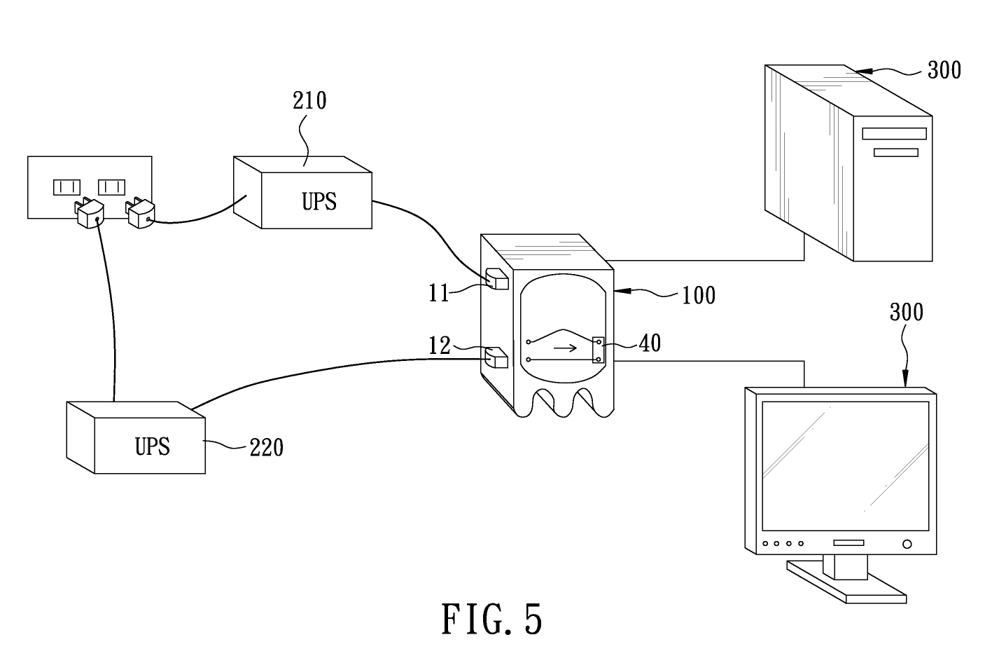

FIG. 5 shows a second example of the preferred embodiment of the present invention in using, wherein the main power supply unit 210 of the external power supply device 200 is an uninterruptible power system (UPS) connected with the main power supply input terminal 11 of the always-on system 100, and the bypass power supply unit 220 of the external power supply device 200 is another uninterruptible power system (UPS) connected with the bypass power supply input terminal 12. It functions the same as the preferred embodiment does.

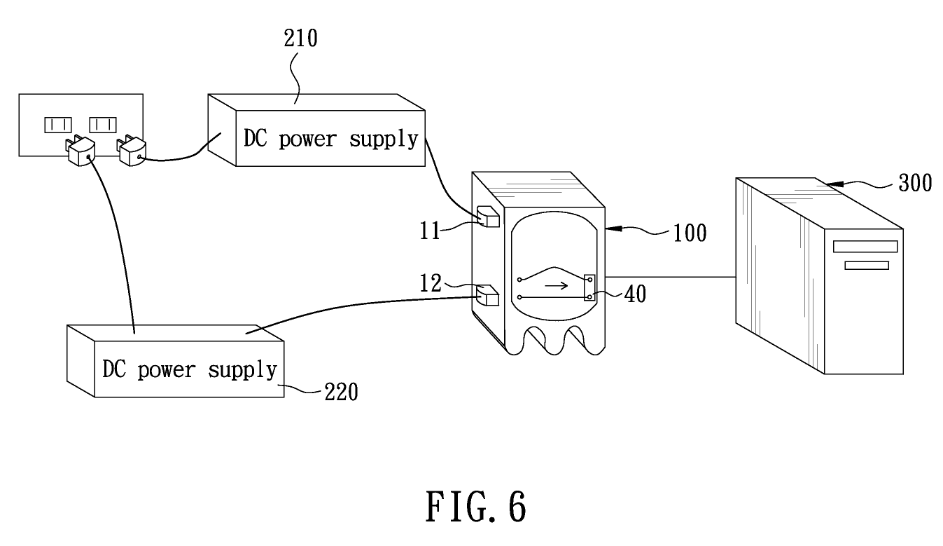

FIG. 6 shows a third example of the preferred embodiment of the present invention in using, wherein the main power supply unit 210 of the external power supply device 200 is a DC power supply connected with the main power supply input terminal 11 of the always-on system 100, and the bypass power supply unit 220 of the external power supply device 200 is another DC power supply connected with the bypass power supply input terminal 12. It also functions the same as the preferred embodiment does.

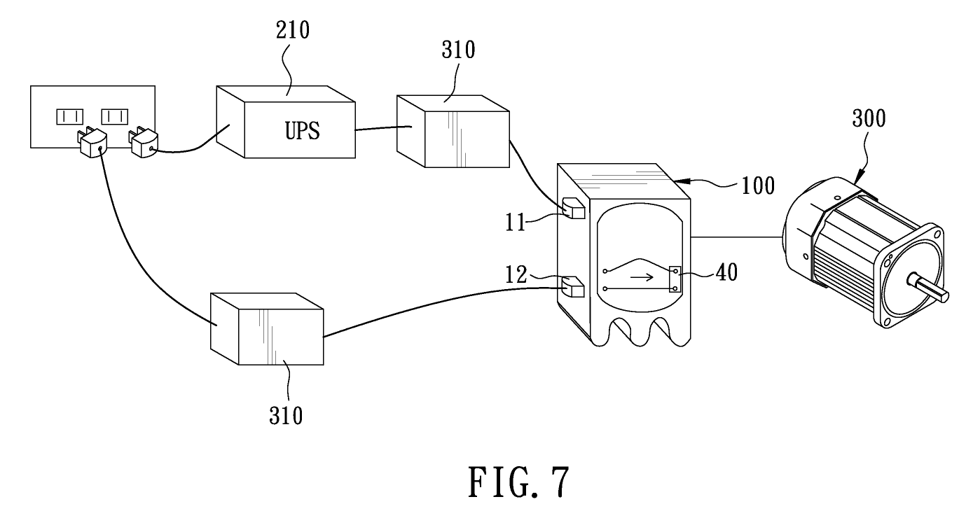

FIG. 7 shows a fourth example of the preferred embodiment of the present invention in using, wherein the load 300 is a motor, and the main power supply unit 210 and the bypass power supply unit 220 are respectively connected with a frequency converter 310. It also functions the same as the preferred embodiment does.

While the preferred embodiment of the invention has been described above, it will be recognized and understood that various modifications may be made therein and the appended claims are intended to cover all such modifications that may fall within the spirit and scope of the invention.

What is claimed is:

1. An always-on system connected with an external power supply device at its one side for providing diverse power supplies and a load at another side, said external power supply device composed of a main power supply unit and a bypass power supply unit, said always-on system comprising:
a power supply input unit provided with a main power supply input terminal, a bypass power supply input terminal and a power supply asynchronous detecting circuit that is respectively connected with said main power supply input terminal, said bypass power supply input terminal detecting if a phase of a power supply transmitted from said main power supply input terminal is synchronous with that of another power supply transmitted from said bypass power supply input terminal;
a protection circuit unit connected with said power supply input unit at its one side for protecting said load from damaged;
a power supply switch unit connected with said protection circuit unit at its one side, able to select said main power supply input terminal or said bypass power supply input terminal to provide power for said always-on system to keep said load operating continuously without being affected when one of said main power supply input terminal and said bypass power supply input terminal is being installed or uninstalled; and
a control unit connected with said power supply switch unit at its one side and able to generate an enabling signal to control said power supply switch unit to select said main power supply input terminal or said bypass power supply input terminal for being transmitted with external power supply when said external power supply device is being installed or uninstalled.

2. The always-on system as claimed in claim 1, wherein said protection circuit unit is provided with a filtering circuit, a delay protection circuit and a error protection circuit, said filtering circuit connected with said main power supply input terminal and said bypass power supply input terminal of said power supply input unit respectively at its one side to isolate noise of surge and harmonic created inside said always-on system and connected with said delay protection circuit, said error protection circuit and said load respectively at its another side, said delay protection circuit and said error protection circuit respectively connected with said power supply switch unit.

3. The always-on system as claimed in claim 2, wherein said delay protection circuit is employed to prevent external power supply from generating intermittent signals that provoke said power supply switch unit to function in error.

4. The always-on system as claimed in claim 2, wherein said error protection circuit is used to automatically select said main power supply input terminal to provide power from another external power supply in case that said bypass power supply input terminal is an open circuit, but selected by said always-on system.

5. The always-on system as claimed in claim 2, wherein said error protection circuit is used to automatically select said bypass power supply input terminal to provide power from another external power supply in case that said main power supply input terminal is an open circuit, but selected by the always-on system.

6. The always-on system as claimed in claim 1, wherein said control unit is operated manually.

7. The always-on system as claimed in claim 2, wherein said power supply switch unit is a switch circuit base on transistors.

8. The always-on system as claimed in claim 7, wherein said transistors are insulated gate bipolar transistors (IGBTs).

9. The always-on system as claimed in claim 2, wherein said power supply switch unit is a switch circuit based on relays.
